(19) United States
(12) Patent Application Publication
(10) Pub. No.: US 2018/0247363 A1
(43) Pub. Date: Aug. 30, 2018

(54) FEATURE-BASED PRODUCT RECOMMENDATIONS

(71) Applicant: Home Depot Product Authority, LLC, Atlanta, GA (US)

(72) Inventors: Shubham Agarwal, Atlanta, GA (US); Huiming Qu, Atlanta, GA (US); Shawn Coombs, Smyrna, GA (US); Estelle Afshar, Atlanta, GA (US); Rini Devnath, Atlanta, GA (US); Prat Vemana, Marietta, GA (US); Xiquan Cui, Brookhaven, GA (US)

(21) Appl. No.: 15/442,252

(22) Filed: Feb. 24, 2017

(51) Int. Cl. G06Q 30/06

(52) U.S. Cl. CPC G06Q 30/0631; G06Q 30/0629

(57) ABSTRACT

A method of providing purchase recommendations to a user may include tracking user comparisons of products on an electronic commerce system, receiving a user selection of an anchor product from the products through an electronic user interface of the electronic commerce system, designating a recommended product from the products for recommendation to the user through the electronic commerce system according to a frequency with which the recommended product is compared with the anchor product based on the tracking, and presenting the designated recommended product to the user responsive to the user's selection of the anchor product.

### FIELD OF THE DISCLOSURE

This disclosure is generally directed to providing product recommendations, including providing feature-based recommendations for products.

### BACKGROUND OF RELATED ART

Both a retailer and its customers can benefit from the retailer providing recommendations for products that may be of use to the customers. The retailer may provide product recommendations on a website, in a brick-and-mortar store, or otherwise. Recommendations may increase the retailer's sales, and may introduce useful or necessary products to the customer that the customer may otherwise not have found or been aware of

Numerous websites and retailers provide alternative product purchase recommendations. Many websites, however, provide alternative product recommendations that are not as finely-tuned to the customer's needs as possible, or do not ideally account for which products past users have found to be acceptable alternatives.

### SUMMARY

An example method of providing purchase recommendations to a user may include tracking user comparisons of products on an electronic commerce system and receiving a user selection of an anchor product from the products through an electronic user interface of the electronic commerce system. The method may further include designating a recommended product from the products for recommendation to the user through the electronic commerce system according to a frequency with which the recommended product is compared with the anchor product based on the tracking, and presenting the designated recommended product to the user responsive to the user's selection of the anchor product.

An example method of providing purchase recommendations to a user may include tracking user selections of features of a plurality of reference products on an electronic commerce system, determining and storing a ranking of the features, the ranking based on the tracked user selections, and causing a listing of features of at least one of the reference products to be displayed to a user in the electronic commerce system, the features in the listing arranged according to the stored ranking.

An example method of providing product recommendations may include tracking user comparisons of products on an electronic commerce system and tracking user selections of features of the products on the electronic commerce system. The method may further include determining and storing a ranking of the features, the ranking based on the tracked user selections, receiving a user selection of an anchor product from reference products through an electronic user interface of the electronic commerce system, and determining, based on the tracked user comparisons, respective frequencies with which the reference products of the products are compared with the anchor product. The method may further include determining, based on the ranking of the features, respective similarities of the reference products to the anchor product, designating a recommended product from the reference products for recommendation to the user through the electronic commerce system according to the determined frequencies and the determined similarities, and presenting the designated the recommended product to the user responsive to the user's selection of the anchor product.

### BRIEF DESCRIPTION OF THE DRAWINGS

FIG. 1 is a flow chart illustrating an example embodiment of a method of providing product purchase recommendations to a user, in embodiments.

FIG. 2 is a block diagram view of an example embodiment of a system for providing product purchase recommendations to a user.

FIG. 3 is a flow chart illustrating an example embodiment of a method of building lists of feature-based product recommendations.

FIG. 4 is a flow chart illustrating an example embodiment of a method of ranking and displaying product features to a user.

FIG. 5 is a flow chart illustrating an example embodiment of a method of selecting and arranging product recommendations and the features of recommended products.

FIG. 6 is an example embodiment of a product recommendation output in an electronic user interface.

FIG. 7 is an example embodiment of a product recommendation output in an electronic user interface.

FIG. 8 is an example embodiment of a product recommendation output in an electronic user interface.

FIG. 9 is a diagrammatic view of an example embodiment of a user computing environment.

FIG. 10 is a diagrammatic and flow chart view of an example embodiment of a method of building lists of feature-based recommendations.

### DETAILED DESCRIPTION

The present disclosure includes a system and methods for providing product purchase recommendations. The recommendations may be provided in conjunction with the viewing, selection, or purchase of a so-called “anchor product” through an electronic user interface, such as one on a website of an electronic commerce system, a mobile application associated with an electronic commerce system, a kiosk associated with an electronic commerce system in a brick-and-mortar store, or elsewhere. Further, the recommendations may be provided by an in-store associate to a customer based on that customer's question about or interest in a product. The recommendations may include products that are similar to the anchor product based on features in common with the anchor product and/or products that are similar to the anchor product on the basis of previous user product comparisons. For the remainder of this disclosure, recommendations will generally be described as being provided on a website. Such disclosure is by way of example only. The same or similar functionality described herein as being provided on or through a website may also be provided through a mobile application, in-store kiosk, or otherwise.

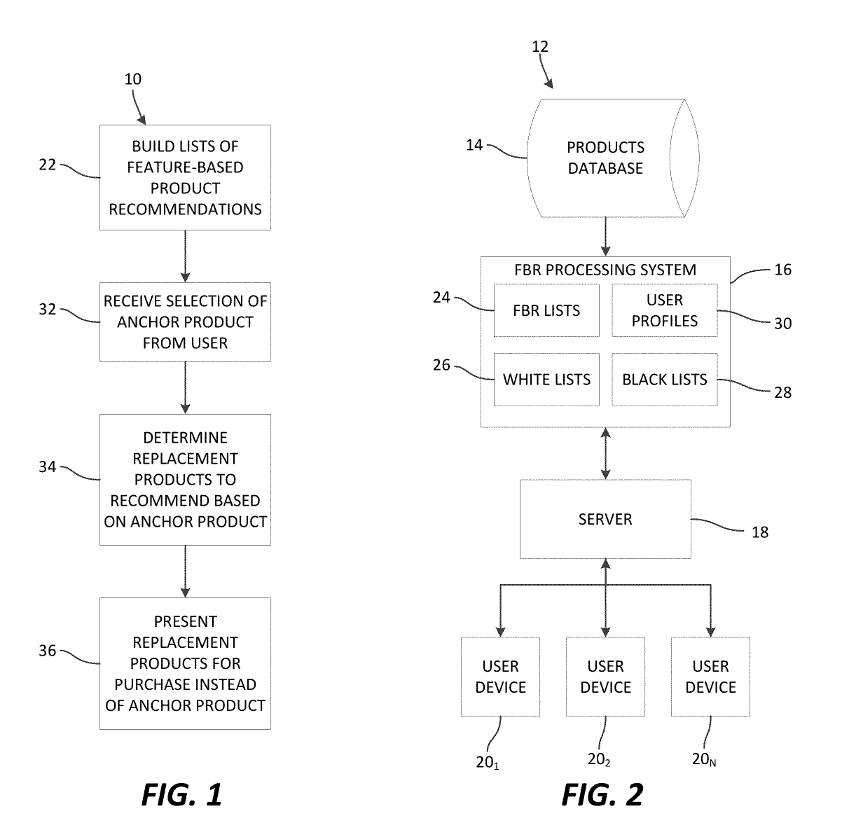

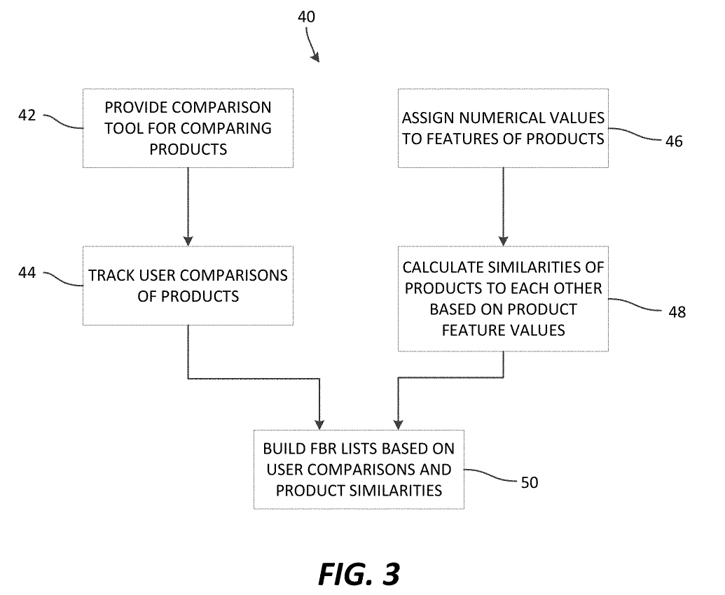

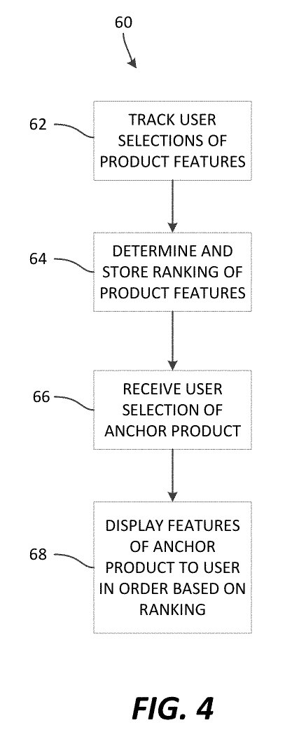

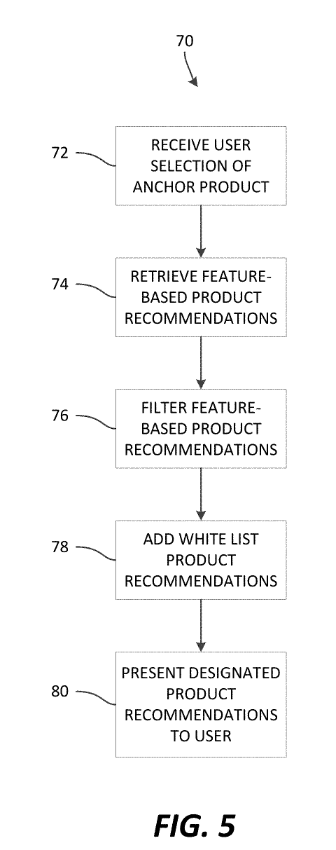

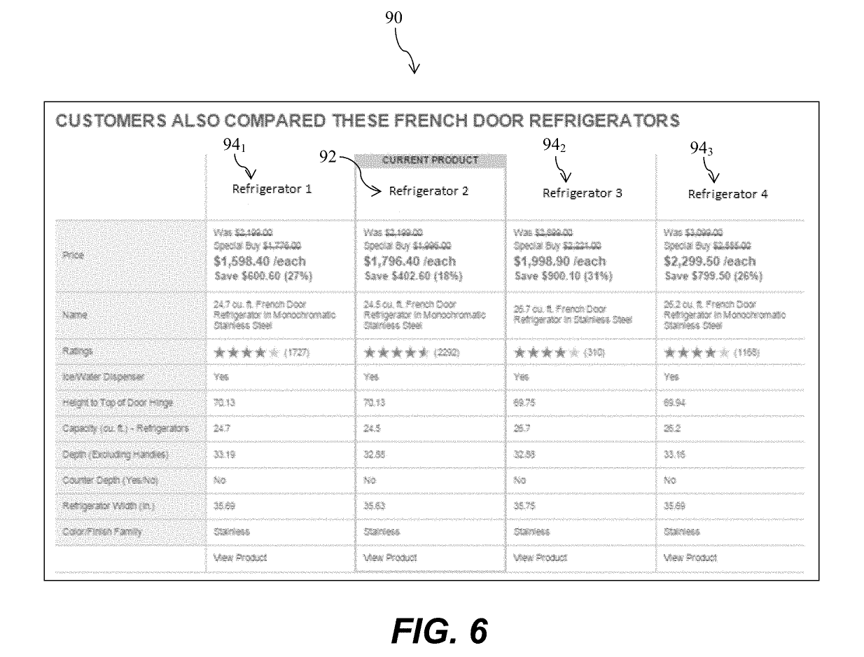

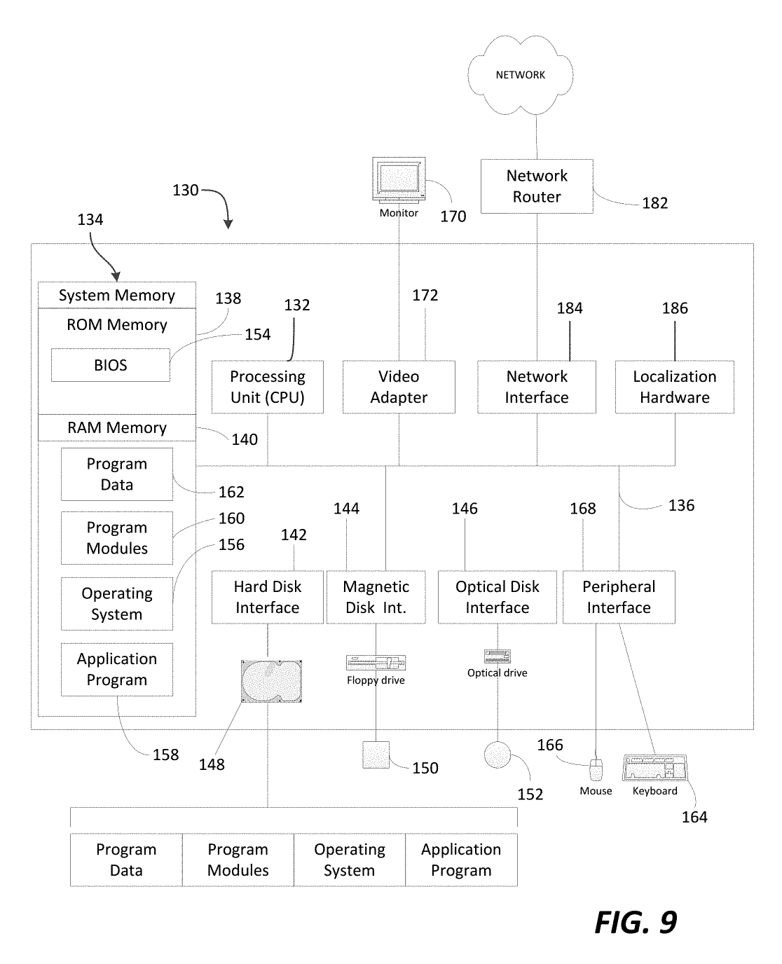

First, with respect to FIGS. 1 and 2, an illustrative method and illustrative system for providing product recommendations will be described at a high level. With respect to FIG. 3, an illustrative method for building lists of feature-based product recommendations will be described. With respect to FIG. 4, an illustrative method for selecting products to recommend from a list of feature-based product recommendations and presenting those products will be described. With respect to FIG. 5, an illustrative method of selecting and arranging product recommendations and the features of recommended products will be described. With respect to FIGS. 6, 7, and 8, various aspects of graphically presenting product recommendations will be described. Finally, with respect to FIG. 9, an illustrative computing environment that may be used in conjunction with the methods and processes of this disclosure will be described.

Reference will now be made in detail to embodiments of the invention, examples of which are illustrated in the accompanying drawings. FIG. 1 is a flow chart of an illustrative method 10 for providing product purchase recommendations to a customer. FIG. 2 is a block diagram of an illustrative system 12 for providing product purchase recommendations to a user. The method 10 of FIG. 1 and the system 12 of FIG. 2 are described in conjunction below.

Generally, the method 10 may include receiving a selection of a product from a user and presenting recommended products based on the user-selected product. A product selected by a user, with which recommendations may be provided according to the present disclosure, may be referred to as an “anchor product.” The product recommendations may include, for example, products that have similar features to the anchor product and/or products that are often compared to the anchor product.

Product recommendations according to the present disclosure may be provided, for example, as alternatives to the anchor product. Accordingly, product recommendations may be provided to enable the user to make an informed purchase decision by informing the user of the available options, or to provide the user with alternatives to discontinued or out-of-stock products, for example, or for other purposes.

The system 12 generally includes computer hardware and functional capability for carrying out the method and other methods and functions of this disclosure. The system 12 may include a products database 14, a Feature Based Recommendation (“FBR”) processing system 16, and a server 18 in electronic communication with a plurality of user devices 20₁, 20₂, . . . , 20_{N}, which may be referred to individually as a user device 20 or collectively as user devices 20. The system 12 may also perform other methods of this disclosure and may provide one or more electronic user interfaces and/or graphical presentations of this disclosure. The system 12 may also host (e.g., through the server 18 in conjunction with the FBR processing system 16) or otherwise provide one or more websites, mobile applications, and the like described in this disclosure, in embodiments. Example hardware that may find use in the various components of the system 12 will be described later in this disclosure with respect to FIG. 9.

With continued reference to FIG. 1, the method 10 will be described in terms of a user, such as a customer, interacting with a website. The server 18 may host or provide that website, and accordingly may receive input from the user through the website. The server 18 may exchange information with the FBR processing system 16 to carry out one or more steps of the method 10, in embodiments. In other embodiments, the server 18 and the FBR processing system 16 may be the same processing system or apparatus, which may perform one or more aspects of the method.

The method 10 may be performed, in part or in full, by a retailer, in embodiments. That is, the system may be owned or operated by or on behalf of a retailer, in embodiments. The method 10 may also be carried out, in full or in part, by some other type of entity. A website having the features referenced herein may be the website of a retailer, and the brick-and-mortar stores referenced herein may be stores of the same retailer. Additionally or alternatively, a website having the features described herein and the brick-and-mortar stores may be associated with different entities. A website having the features described herein may list and sell items sold by the retailer, in embodiments. Additionally or alternatively, such a website may list and sell items sold by third parties.

The method 10 may include a step 22 of building lists of feature-based product recommendations. An embodiment of step 22 is illustrated in and will be described (as a method) in greater detail with respect to FIG. 3. With continued reference to FIGS. 1 and 2, the list building step 22 may generally account for two types of information, in an embodiment. First, the list building step 22 may include utilizing records of product comparisons in the products database to determine which products are compared with each other by users of the website. Such comparisons may be through an explicit comparison tool provided on the website, through co-viewed products by a single user, or co-viewed products in a single browsing session, in embodiments. Accordingly, it should be understood that the products database 14 may include data respective of browsing behavior of a user, of a browsing session, or explicit comparisons, etc. User browsing behavior may also be tracked or determined through the use of cookies or other data stored on the user devices. Second, the list building step 22 may include a mathematical analysis of the similarity of a plurality of products, each having information stored in the product database, to each other on a feature-by-feature basis.

In addition to records of product comparisons made by users, the products database 14 may also include records of user feature selections. Such information may be used to create ranked lists of features, in embodiments, as will be described in detail later in this disclosure. Additionally or alternatively, such information may be stored in the FBR system 16, in embodiments.

The list building step 22 may result in a set of lists of feature-based recommendations (designated in FIG. 2 as “FBR lists” 24) stored in memory of the FBR processing system 16. In an embodiment, the FBR lists 24 may include one or more respective lists for each product with a recorded comparison in the products database 14, or for some subset of those products, or for each product with information stored in the products database, or some subset of those products. That is, each product associated with data in the products database 14 may have its own FBR list(s), in an embodiment.

An FBR list may be capped at a defined number of additional items for each product, in embodiments. For example, the FBR list for a product may be capped at five (5), eight (8), or ten (10) additional items or combinations of items, for example. The cap may be set at any number as desired.

The FBR processing system 16 may also store one or more white lists 26 of items that may be recommended regardless of the frequency with which they are compared by users to a given anchor product and regardless of the mathematical similarity to the anchor product, one or more black lists 28 of products for which the system 12 may suppress recommendation to the user even if they often compared to the anchor product and/or are mathematically similar to the anchor product, and one or more user profiles 30 that may be used to recommend products and services. The use of the white lists 26, black lists 28, and user profiles 30 will be described in greater detail later in this disclosure.

With continued reference to FIGS. 1 and 2, the method 10 may further include a step 32 of receiving a selection of an anchor product from a user. The selection may be received, for example, by the FBR processing system 16 from a user device 20 through a website provided by the server 18 or through another electronic user interface such as a mobile application, in-store kiosk, etc. As noted above, the website may be, for example, an e-commerce site associated with or operated by or on behalf of a retailer. The selection may be, for example only, a click on the anchor product on a page of the website, navigation to a product information page of the anchor product on the website, a user action to add the anchor product to the user's shopping cart on the website, etc.

In an embodiment, a selection of an anchor product may be received from a user through a voice search or request through the electronic user interface. For example, the electronic user interface with which the user interacts may be on a mobile application, and the mobile application may be configured to capture voice search requests from the user. The server or user device may be configured with voice recognition software to parse the user's voice search or voice request to determine an anchor product. In response to the voice search or voice request, the server may provide a list of FBR recommendations to the user through the electronic user interface, as described below.

In another embodiment, a selection of an anchor product may be received from a user through a text-based (e.g., SMS or MMS) request. For example, the user may transmit a text message order for an anchor product from a user device 20 and, in response, the server 18 may transmit a list of FBR recommendations to the user device.

In another embodiment, a selection of an anchor product may be received from a user through a chat window or program, such as a chat window or program executing in or on top of a website provided by the server 18. The chat program may include a chat with a human operator and/or a computerized “chat bot.” In such an embodiment, responsive product recommendations may be provided in the chat window or program, or may be otherwise provided as discussed in this disclosure.

The method 10 may further include a step 34 of determining replacement products to recommend to the user for purchase responsive to the anchor item selection by the user. The determining step 34 may include designating products from an FBR list 24 associated with the anchor product for recommendation to the user. Designating products for recommendation to the user may include filtering an FBR list 24 associated with the anchor item, in an embodiment. The FBR processing system 16 may access a list in the FBR lists 24 that is associated with the anchor item and filter the items on that list to create a set of products to be recommended to the user. The filtering may account for entries associated with the anchor item on a black list 28 associated with the item, may account for a user profile 30 associated with the user, and/or other filtering criteria. Illustrative filtering will be described in greater detail with respect to FIG. 4. Selecting products for recommendation to the user may additionally include, for example, selecting items off of a white list in the white lists 26 that is associated with the anchor product.

With continued reference to FIGS. 1 and 2, the method 10 may further include a step 36 of presenting the designated products to the user. The designated products may be presented, for example, in a side-by-side listing with the anchor item. Example interface listings of designated products are illustrated in and will be described in greater detail with respect to FIGS. 6, 7, and 8.

The method 10 advantageously provides product recommendations to customers on a website and allows the customers to purchase recommended products with a reduced number of clicks. Instead of separately selecting and separately navigating to a product information page of each of the recommended additional products to view the additional products or add one of the additional products to cart, the method provides a quicker way for the customer to purchase an alternative to the anchor product.

The “user” noted in the method may be a customer that is shopping on a website or mobile application provided by the server 18 with a user device 20, in embodiments. The user device 20 may be a personal computer, user mobile computing device, or other computing device. Additionally or alternatively, the server 18 may provide all or part of an in-store checkout or informational environment or digital price display information, and the user devices 20 may be in-store kiosks, in an embodiment.

FIG. 3 is a flow chart illustrating an embodiment of a method 40 for building feature-based recommendation lists. The method 40 may find use as the first step 22 in the method of FIG. 1, in an embodiment.

The method 40 will be described with respect to a set of products. The set of products may include a plurality of products that are commercially available through a given user interface, for example. Referring to FIG. 2, the set of products may all have information stored in the products database 14. The underlying source of the set of products may be one or more retailers, in an embodiment. The method 40 will be described with reference to a website, but it should be understood that one or more steps of the method may find use in other environments, such as a mobile application, in-store kiosk, and the like.

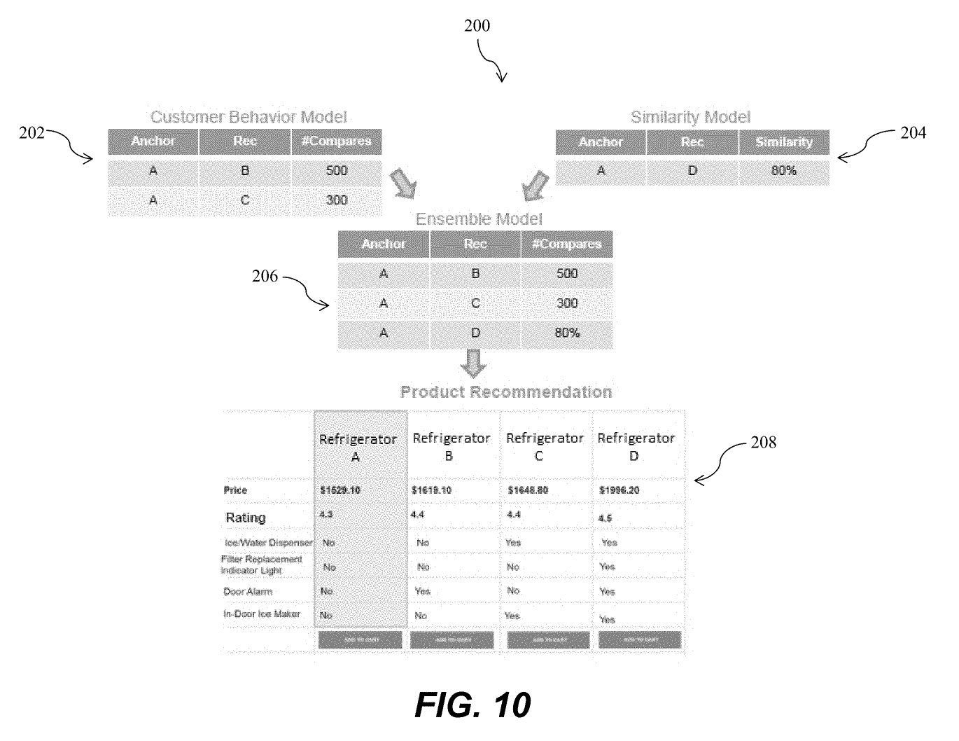

The method 40 of FIG. 3 will further be described with reference to FIG. 10, which is a diagrammatic and flow chart view 200 of the result of several steps of the method 40.

The method 40 may include a step 42 that includes providing a comparison tool to a user for comparing two or more products of the set of products. The comparison tool may be provided, for example, on a website, mobile application, in-store kiosk, or other electronic user interface. The comparison tool may display two or more products with a listing of the respective features of each product, in an embodiment, responsive to a user selection of those two or more products for comparison. For example, in an embodiment, a comparison tool may display two or more products side-by-side, with the values of the same features of the two or more products also displayed side-by-side.

The method 40 may further include a step 44 that includes tracking user comparisons of products. This tracking may include, for example only, recording the frequency that any given two or more products are both selected for comparison with the comparison tool provided in step 42 or another comparison tool. Tracking user comparisons may also include, for example, tracking the frequency with which a single user views any given two or more products within a single browsing session on website (i.e., the percentage or absolute number of single user browsing sessions that include viewing the given two or more products). Tracking user comparisons may also include, for example, tracking the frequency with which a single user views any given two or more products (i.e., over a single or multiple browsing sessions). The tracking user comparisons step may include compiling and storing a listing of all product comparisons, and a frequency of each of those comparisons.

In one embodiment, the step 44 of tracking user comparisons may result in storage of the number of comparisons of different products with each other. In FIG. 10, table 202 illustrates an example in which Anchor Product A has been compared to Product B five hundred (500) times and to Product C three hundred (300) times.

The method 40 may further include a step 46 that includes assigning numerical values to the features of the plurality of products in the set of products. Many features may be natively associated with numerical values—e.g., dimensions. The assigning numerical values step may include normalizing such values to common units (i.e., such that all lengths for a given product type are in a given unit, all volumes for a given product type are in a given unit, and so on). Many other features, however, may not be natively associated with numerical values—e.g., colors, materials. The assigning numerical values step 46 may include assigning numerical values to such non-numerical features so that a calculation of the similarity of two products can account for those features.

Assigning numerical values to non-numerical features may be performed in a number of ways. For example, in an embodiment, each possible characteristic for a given feature may be assigned a value on a single continuum—i.e., if the feature is color, “black” may be assigned a first value, “white” another value, “red” another value, and so on. In another embodiment, each characteristic for a given feature may be assigned its own binary designation—i.e., if the feature is color, each product may be assigned a binary value (yes/no) for each color.

Different types of products may include different features. Accordingly, each of the products may be assigned into one of a plurality of product categories, with each product category having its own feature set, with each product within a given category having numerical values for each feature of the feature set for that category.

The step 46 of assigning numerical values to features may also include a sub-step of extracting features from product listings. For example, textual descriptions of features may be extracted from product listings for conversion into numerical form.

The step 46 of assigning numerical values to features may also include a sub-step of extracting features from user-generated content. For example, textual descriptions of features of products may be extracted from user reviews of those products.

The method 40 may further include a step 48 that includes calculating similarities of products based on the product feature values. The calculating similarities step 48 may include, for example, calculating the similarity of each product in a given category to each other product in that category. Calculating the similarity of products may include, for example, applying one or more of a cosine similarity model, a Euclidean distance model, a Manhattan distance model, a weighted cosine similarity model, a weighted Manhattan distance model, or some other mathematical analysis. Referring to FIG. 10, table 204 illustrates one example calculated similarity, with Product D being 80% similar to Anchor Product A.

The method 40 may further include a step 50 that includes building Feature-Based Recommendation (“FBR”) lists for one or more of the products in the product set. In an embodiment, each product in the product set may have its own FBR list that includes a plurality of products that may be recommended to a customer for purchase as alternatives to that product.

In an embodiment, an FBR list for a given product may include a number of products that are most frequently compared with the product (as determined in step 44) as well as a separate number of products that are most similar to the product (as determined in step 48)—i.e., the results of step 44 may be concatenated with the results of step 48. For example, referring to FIG. 10, table 206 illustrates one such concatenated list, in which Products B, C, and D from tables 202 and 204 have been added to a FBR list for Anchor Product A. In another embodiment, an FBR list for a given product may include a set of products that are both frequently compared with the product and are similar to the product—i.e., the results of step 44 may be compared with the results of step 48, and the overlap between the two sets of products may be used to generate FBR lists.

In embodiments, the method of FIG. 3 advantageously results in a set of alternatives to a plurality of anchor products that are determined to be similar to the anchor product, either by virtue of user action (i.e., through comparisons) or mathematical analysis. Accordingly, such lists can be used to provide alternative product recommendations to users, as generally described above with respect to FIG. 1.

As will be described in greater detail elsewhere in this disclosure, in embodiments, items from an FBR list respective of an anchor product may be presented to a user responsive to user selection of the anchor product. Referring to FIG. 10, Products B, C, and D on FBR list 206 may be presented to a user, responsive to user selection of Anchor Product A, in a product recommendations interface, a portion 208 of which is illustrated diagrammatically in FIG. 10.

FIG. 4 is a flow chart illustrating an example method 60 of ranking and displaying product features for a user. The method 60 may be used, for example, to create an order of features for one or more products that may be used in the display of those product features to a user.

The method 60 will be described with respect to a set of products. The set of products may include a plurality of products that are commercially available through a given user interface, for example. The underlying source of the set of products may be one or more retailers, in an embodiment. The method 60 will be described with reference to a website, but it should be understood that one or more steps of the method may find use in other environments, such as a mobile application, in-store kiosk, and the like.

The method 60 may include a step 62 that includes tracking user selections of product features. The tracking user feature selections step 62 may include, in an embodiment, determining the frequency with which users select products having a given feature on the website. Additionally or alternatively, the tracking user feature selections step 62 may include determining the frequency with which users sort products by particular features or search for particular features. Other user selections of such features may additionally or alternatively be tracked, in embodiments.

The method 60 may further include a step 64 that includes determining and storing a ranking of features based on the feature tracking in step 62. The feature ranking may include ranking features that are selected more frequently by users higher than features that are selected less frequently. The feature ranking step may include determining and storing a feature ranking separately for each of a plurality of product categories. In an embodiment, the feature ranking step 64 may include storing, for each product category, an ordered list of all product features, from most-frequently-selected by users to least-frequently-selected by users.

The method 60 may further include a step 66 that includes receiving a user selection of a product. The user selection may be through, for example, a webpage or website. The user selection may be, for example, a user navigation to a product information page respective of the product, an inclusion of the product in a multi-product comparison with a product comparison tool, or some other user selection.

The method 60 may further include a step 68 that includes displaying the features of the product in an order according to the feature ranking determined in step 64. The features may be displayed, for example, in a product comparison tool, on a product information page, or otherwise.

The method 60 of FIG. 4 advantageously accounts for user input (in the form of selections of product features) to display products to the user with the features that a user is most likely to be interested in listed first. As a result, when viewing products or comparing products, a user may be more able to review the most pertinent information with respect to the product more quickly.

FIG. 5 is a flow chart illustrating an example embodiment of a method 70 of selecting and arranging product recommendations and the features of recommended products. The method 70 may be applied, for example, to provide alternative product recommendations to a user. Such product recommendations may be provided, for example, upon selection of an anchor product through a website, to offer replacement products for a discontinued or out-of-stock product, or for some other reason.

The method 70 may include a step 72 that includes receiving a selection of an anchor product from a user. The selection may be received, for example, by the FBR processing system from a user device through a website provided by the server or through another electronic user interface such as a mobile application, in-store kiosk, etc. As noted above, the website may be, for example, an e-commerce site associated with or operated by or on behalf of a retailer. The selection may be, for example only, a click on the anchor product on a page of the website, navigation to a product information page of the anchor product on the website, a user action to add the anchor product to the user's shopping cart on the website, etc.

In an embodiment, a selection of an anchor product may be received from a user through a voice search or request through the electronic user interface. For example, the electronic user interface with which the user interacts may be on a mobile application, and the mobile application may be configured to capture voice search requests from the user. The server or user device may be configured with voice recognition software to parse the user's voice search or voice request to determine an anchor product. In response to the voice search or voice request, the server may provide a list of FBR recommendations to the user through the electronic user interface, as described below.

In another embodiment, a selection of an anchor product may be received from a user through a text-based (e.g., SMS or MMS) request. For example, the user may transmit a text message order for an anchor product from a user device and, in response, the server may transmit a list of FBR recommendations to the user device.

The method 70 may further include a step 74 that includes retrieving a set of feature-based product recommendations. In an embodiment, the retrieving step 74 may include retrieving a predetermined number of feature-based product recommendations from an FBR list associated with the anchor product.

The method 70 may further include a step 76 that includes filtering the retrieved feature-based product recommendations. One or more filters may be applied, in an embodiment, where “filtered” recommendations are removed from eligibility for recommendation responsive to the user anchor product selection in step 72. Example filters are described below. The filtering step 76 may involve a single one of the filters set forth below, or a combination of two or more the filters set forth below. The filtering step 76 may also involve additional filters not explicitly set forth below, in embodiments.

A first filter that may be applied may be a skill level of the user (e.g., professional v. non-professional), as determined by retrieving information from a profile associated with the user (e.g., from the user profiles 30 of FIG. 2). The user skill level filter may be applied to ensure that products intended for high-skill level users are recommended to high-skill-level users and that products intended for low-skill-level users are recommended to low-skill-level users.

In addition to a user's skill level, other user information from the user profiles 30 of FIG. 2 may be utilized to filter retrieved feature-based product recommendations. For example, whether or not a user prefers “smart home” products may be used to filter product recommendations for, e.g., WiFi-enabled products.

Still further, a user's purchasing and browsing history may be tracked to determine and store certain user preferences, e.g., a user's price sensitivity (i.e., tendency towards less expensive or more expensive products), personal style (e.g., tendency to purchase or view products having particular materials, colors, etc.), a user's brand affinity, and the like. Such user preference information may be stores in a user profile 30 respective of the user and may be used to filter FBR lists to make recommendations to the user.

Another filter that may be applied may be a black list (e.g., using one or more of the black lists 28 of FIG. 2). Products on a black list may include, for example, products that the retailer does not want to promote, or that the retailer does not want to promote with given anchor products.

Each product may have its own black list, in an embodiment. In addition, a global black list may be stored (e.g., in the black lists 28 of FIG. 1) and used (e.g., in conjunction with a product-specific black list) in the black list filtering. A global black list may include, for example, discontinued products. In addition to anchor-product specific and global black lists, black lists may also be established for product classifications or other item groupings.

Another filter that may be applied may include a location-based filter. A location-based filter may be based on the location of the user, in an embodiment. For example, one possible location-based filter that may be applied may filter out products with requirements that are not available in the user's location. For example, if natural gas is not available in the user's location, products that require natural gas may be filtered out. Of course, other location-based filters may be applied, in embodiments.

Another filter that may be applied may be expert recommendations. For example, expert-recommended products may be moved up in the list of retrieved feature-based recommendations. Expert recommendations may come from industry experts, in an embodiment, that are affiliated with the purveyor of the website.

Another filter that may be applied is to filter out products that do not have sufficient stock or inventory available to fulfill the user's order.

Another filter that may be applied is to filter out products that are not available in a delivery channel selected by the user. The delivery channel selection may be received along with a selection of anchor product from the user at step 72.

In embodiments, determining if a product that may be recommended is available in the same delivery channel as the anchor product may include determining if the two products are available from the same source (e.g., the same warehouse or other physical location). In addition, it may also be determined if a to-be-recommended product is available for delivery on the same day or within the same time frame as the anchor product.

Another filter that may be applied may be to filter out products that do not meet a user review rating threshold. Each product may be associated with a user review rating on the website and may be used for this filter.

The method 70 may further include a step 78 that includes adding white-listed products to the set of feature-based product recommendations (e.g., using the white lists 26 in FIG. 2). In an embodiment, each product may be associated with a white list. In another embodiment, each product may be associated with a category, and each category may be associated with a white list.

The process of retrieving a set of feature-based product recommendations (at step 74), filtering that set (at step 76), and adding white list items (at step 78) may be considered designating products for recommendation to a user. In an embodiment, designating products for recommendation to a user may include one or more of retrieving a set of feature-based product recommendations, filtering that set, and adding white list items.

The method 70 may further include a step 80 that includes presenting designated products as recommendations to the user. The presentation of designated products may be provided in a side-by-side product comparison, in an embodiment.

FIG. 6 is an example embodiment of a product recommendation output 90 in a user interface. The product recommendation output 90 may be provided, in an embodiment, on a website responsive to a user selection of an anchor product. For example, the product recommendation output 90 of FIG. 6 may be provided in a pop-up window responsive to a user selection of the anchor product on the website.

The example output 90 of FIG. 6 includes an anchor product 92 and three feature-based product recommendations 94₁, 94₂, 94₃, presented side-by-side. The values of the same features (e.g., price, name, brand, etc.) of the four products 92, 94₁, 94₂, 94₃ are presented side-by-side.

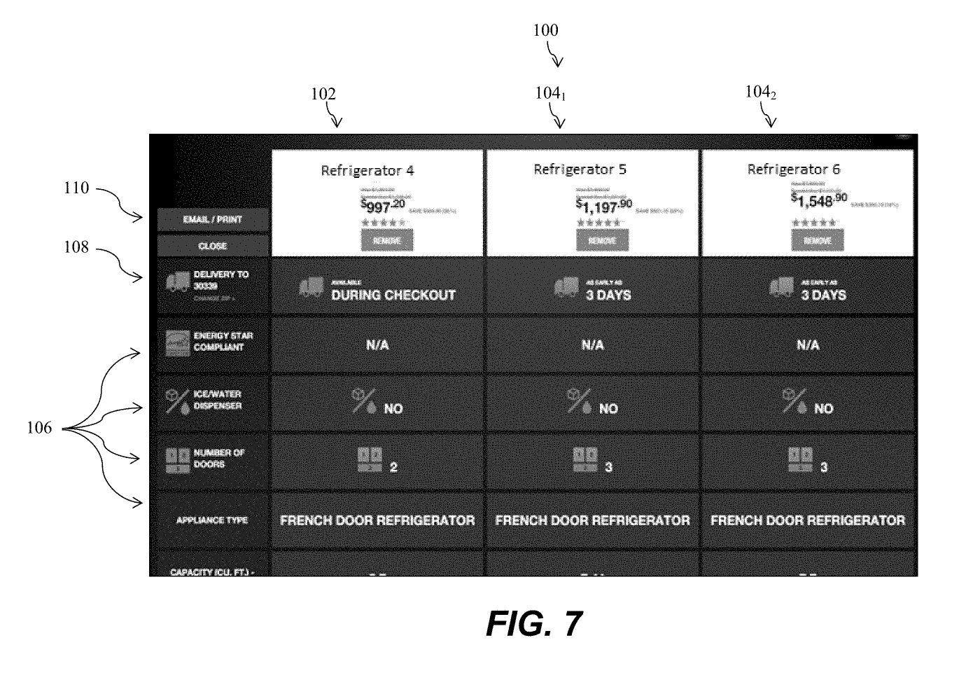

FIG. 7 is an example embodiment of a product recommendation output 100 in a user interface. The product recommendation output 100 of FIG. 7 may be provided, in an embodiment, on a kiosk in a brick-and-mortar store. For example, the product recommendation output 100 of FIG. 7 may be provided responsive to a user selection of an anchor product 102 on the kiosk and may include one or more FBR product recommendations. Two such recommendations 104₁, 104₂ are illustrated in FIG. 7.

As illustrated in FIG. 7, a product recommendation output 100 may include, e.g., features 106 of the anchor product and recommended products, an available delivery channel 108 of the anchor product and recommended products, and an option 110 (i.e., user interface element 110) to email information respective of the anchor product and/or the recommended products to the user.

Many variations may be made to the example product recommendation outputs 90, 100 of FIGS. 6 and 7. For example, more or fewer product recommendations than are illustrated in FIG. 6 or 7 may be provided. In another example, an indication of which features are different between the products may be provided—i.e., the feature differences may be accentuated. Such feature accentuation may be provided, for example, by altering the font for such features, providing a box or circle around such features, and the like.

In an embodiment, expert recommendations, pro user preferences, and/or best-selling items may be noted in the output. For example, a textual or graphical indicator of an expert's recommendation associated with a product, a professional user preference (i.e., a product selected by most professional users), and/or a best-selling status respective of an item may be provided above that product's listing in the output.

In an embodiment, user reviews, or portions thereof, may be provided in the product recommendations output. For example, a row in the output interface may be or may include user review highlights—e.g., one or more aspects of user reviews, such as key terms or feature names, that have been extracted from those user reviews.

In an embodiment, an indication that one or more features are trending may be provided in the product recommendations output. For example, “up” or “down” arrows may be provided next to a feature description in the product recommendations output to indicate that a given feature is trending up or down. In an embodiment, determining whether a given feature is trending up or down may be performed according to tracking user feature selections, as detailed elsewhere in this disclosure.

In an embodiment, a recommendations output may include a listing of all features of the anchor product and the recommended products. Additionally, in an embodiment, the recommendations output may initially list only a subset of the features of the anchor product and the recommended products and may provide a button or other user interface element for a user to select, responsive to which a listing of all features of the anchor product and the recommended products may be displayed. Similarly, in an embodiment, the recommendations output may include a button or other user interface element for a user to select, responsive to which more product recommendations may be shown.

In an embodiment, a recommendations output may include an earliest delivery indication. For example, a row of the product recommendations output may list the earliest possible delivery date for the anchor product and the product recommendations, in an embodiment.

In an embodiment, a recommendations output may include a user input interface element. Responsive to user input with the interface element, the recommendations output may be dynamically or otherwise automatically updated. For example, in an embodiment, a slider user interface element may be provided (for example, with respect to price) and, responsive to user actuation of the slider, the recommendations output may be dynamically updated to include products having prices in the price range selected by the user with the slider. Of course, the recommendations output may be dynamically updated responsive to user input with respect to other features or options, in embodiments.

In an embodiment, the recommendations output may include a user input interface element to enable a user to mark a product recommendation as a favorite item or disfavored item, or to indicate which, if any, of the product recommendations have been marked by the user as a favorite. User-marked favorite products may be stored in a user profile associated with the user.

In an embodiment, the recommendations output may include meta data with respect to the product recommendations. For example, one row of the recommendations output may include a frequency with which users compare each product recommendation with the anchor product, a numerical similarity of each product recommendation to the anchor product, and the like.

In an embodiment, the recommendations output may include a user input interface element to enable a user to provide feedback with respect to the product recommendations, or a specific one or more of the recommendations. Response to user selection of the element, a pop-up feedback window may be provided, in an embodiment.

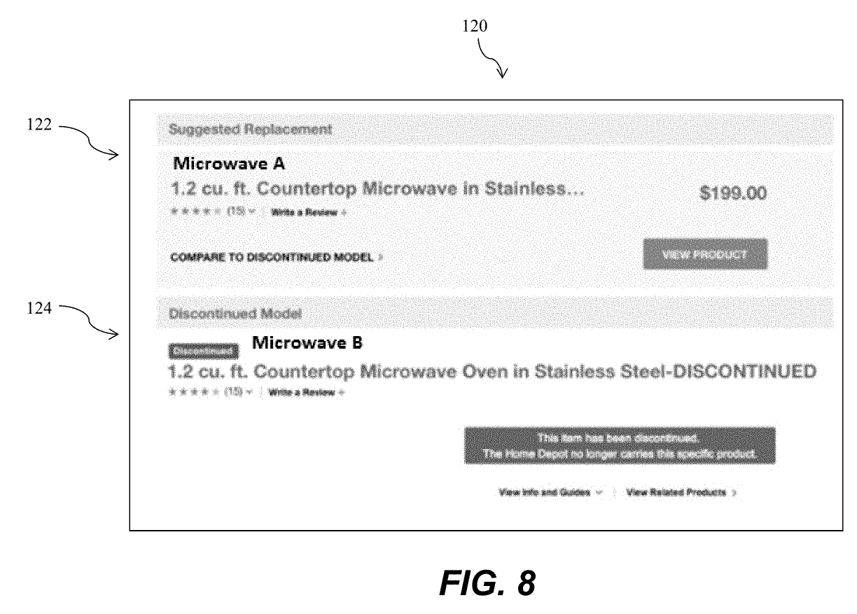

FIG. 8 is an example embodiment of a product recommendation output 120 in a user interface. The product recommendation output of FIG. 8 may be provided, in an embodiment, on a website responsive to a user selection of a discontinued product 124. As illustrated, a single recommendation 122 may be provided responsive to a user selection of a discontinued product 124, in an embodiment. Alternatively, more than one product may be recommended instead of a discontinued product, in an embodiment.

FIG. 9 is a diagrammatic view of an illustrative computing system that includes a general purpose computing system environment 130, such as a desktop computer, laptop, smartphone, tablet, or any other such device having the ability to execute instructions, such as those stored within a non-transient, computer-readable medium. Furthermore, while described and illustrated in the context of a single computing system 130, those skilled in the art will also appreciate that the various tasks described hereinafter may be practiced in a distributed environment having multiple computing systems 130 linked via a local or wide-area network in which the executable instructions may be associated with and/or executed by one or more of multiple computing systems 130.

In its most basic configuration, computing system environment 130 typically includes at least one processing unit 132 and at least one memory 134, which may be linked via a bus 136. Depending on the exact configuration and type of computing system environment, memory 134 may be volatile (such as RAM 140), non-volatile (such as ROM 138, flash memory, etc.) or some combination of the two. Computing system environment 130 may have additional features and/or functionality. For example, computing system environment 130 may also include additional storage (removable and/or non-removable) including, but not limited to, magnetic or optical disks, tape drives and/or flash drives. Such additional memory devices may be made accessible to the computing system environment 130 by means of, for example, a hard disk drive interface 142, a magnetic disk drive interface 144, and/or an optical disk drive interface 146. As will be understood, these devices, which would be linked to the system bus 136, respectively, allow for reading from and writing to a hard disk 148, reading from or writing to a removable magnetic disk 150, and/or for reading from or writing to a removable optical disk 152, such as a CD/DVD ROM or other optical media. The drive interfaces and their associated computer-readable media allow for the nonvolatile storage of computer readable instructions, data structures, program modules and other data for the computing system environment 130. Those skilled in the art will further appreciate that other types of computer readable media that can store data may be used for this same purpose. Examples of such media devices include, but are not limited to, magnetic cassettes, flash memory cards, digital videodisks, Bernoulli cartridges, random access memories, nano-drives, memory sticks, other read/write and/or read-only memories and/or any other method or technology for storage of information such as computer readable instructions, data structures, program modules or other data. Any such computer storage media may be part of computing system environment 130.

A number of program modules may be stored in one or more of the memory/media devices. For example, a basic input/output system (BIOS) 154, containing the basic routines that help to transfer information between elements within the computing system environment 130, such as during start-up, may be stored in ROM 138. Similarly, RAM 140, hard drive 148, and/or peripheral memory devices may be used to store computer executable instructions comprising an operating system 156, one or more applications programs 158 (such as a Web browser, retailer's mobile app, retailer's point-of-sale checkout and ordering program, and/or other applications that execute the methods and processes of this disclosure), other program modules 160, and/or program data 162. Still further, computer-executable instructions may be downloaded to the computing environment 130 as needed, for example, via a network connection.

An end-user, e.g., a customer, retail associate, and the like, may enter commands and information into the computing system environment 130 through input devices such as a keyboard 164 and/or a pointing device 166. While not illustrated, other input devices may include a microphone, a joystick, a game pad, a scanner, etc. These and other input devices would typically be connected to the processing unit 132 by means of a peripheral interface 168 which, in turn, would be coupled to bus 136. Input devices may be directly or indirectly connected to processor 132 via interfaces such as, for example, a parallel port, game port, firewire, or a universal serial bus (USB). To view information from the computing system environment 130, a monitor 170 or other type of display device may also be connected to bus 136 via an interface, such as via video adapter 172. In addition to the monitor 170, the computing system environment 130 may also include other peripheral output devices, not shown, such as speakers and printers.

The computing system environment 130 may also utilize logical connections to one or more computing system environments. Communications between the computing system environment 130 and the remote computing system environment may be exchanged via a further processing device, such a network router 182, that is responsible for network routing. Communications with the network router 182 may be performed via a network interface component 184. Thus, within such a networked environment, e.g., the Internet, World Wide Web, LAN, or other like type of wired or wireless network, it will be appreciated that program modules depicted relative to the computing system environment 130, or portions thereof, may be stored in the memory storage device(s) of the computing system environment 130.

The computing system environment 130 may also include localization hardware 186 for determining a location of the computing system environment 130. In embodiments, the localization hardware 186 may include, for example only, a GPS antenna, an RFID chip or reader, a WiFi antenna, or other computing hardware that may be used to capture or transmit signals that may be used to determine the location of the computing system environment 130.

The computing environment 130, or portions thereof, may comprise one or more of the user devices 20 of FIG. 2. Additionally or alternatively, the components of the computing environment 130 may comprise embodiments of the FBR processing system 16, server 18, and/or products database 14 of FIG. 2.

While this disclosure has described certain embodiments, it will be understood that the claims are not intended to be limited to these embodiments except as explicitly recited in the claims. On the contrary, the instant disclosure is intended to cover alternatives, modifications and equivalents, which may be included within the spirit and scope of the disclosure. Furthermore, in the detailed description of the present disclosure, numerous specific details are set forth in order to provide a thorough understanding of the disclosed embodiments. However, it will be obvious to one of ordinary skill in the art that systems and methods consistent with this disclosure may be practiced without these specific details. In other instances, well known methods, procedures, components, and circuits have not been described in detail as not to unnecessarily obscure various aspects of the present disclosure.

Some portions of the detailed descriptions of this disclosure have been presented in terms of procedures, logic blocks, processing, and other symbolic representations of operations on data bits within a computer or digital system memory. These descriptions and representations are the means used by those skilled in the data processing arts to most effectively convey the substance of their work to others skilled in the art. A procedure, logic block, process, etc., is herein, and generally, conceived to be a self-consistent sequence of steps or instructions leading to a desired result. The steps are those requiring physical manipulations of physical quantities. Usually, though not necessarily, these physical manipulations take the form of electrical or magnetic data capable of being stored, transferred, combined, compared, and otherwise manipulated in a computer system or similar electronic computing device. For reasons of convenience, and with reference to common usage, such data is referred to as bits, values, elements, symbols, characters, terms, numbers, or the like, with reference to various embodiments of the present invention.

It should be borne in mind, however, that these terms are to be interpreted as referencing physical manipulations and quantities and are merely convenient labels that should be interpreted further in view of terms commonly used in the art. Unless specifically stated otherwise, as apparent from the discussion herein, it is understood that throughout discussions of the present embodiment, discussions utilizing terms such as “determining” or “outputting” or “transmitting” or “recording” or “locating” or “storing” or “displaying” or “receiving” or “recognizing” or “utilizing” or “generating” or “providing” or “accessing” or “checking” or “notifying” or “delivering” or the like, refer to the action and processes of a computer system, or similar electronic computing device, that manipulates and transforms data. The data is represented as physical (electronic) quantities within the computer system's registers and memories and is transformed into other data similarly represented as physical quantities within the computer system memories or registers, or other such information storage, transmission, or display devices as described herein or otherwise understood to one of ordinary skill in the art.

What is claimed is:

1. A method of providing purchase recommendations to a user, comprising:
tracking user comparisons of products on an electronic commerce system;
receiving a user selection of an anchor product from the products through an electronic user interface of the electronic commerce system;
designating a recommended product from the products for recommendation to the user through the electronic commerce system according to a frequency with which the recommended product is compared with the anchor product based on the tracking; and
presenting the designated recommended product to the user responsive to the user's selection of the anchor product.

2. The method of claim 1, further comprising:
providing a comparison tool on the electronic commerce system, wherein tracking user comparisons of the products comprises tracking user comparisons of the products with the comparison tool.

3. The method of claim 1, further comprising:
assigning respective numerical values to a plurality of features of each of the products; and
calculating respectively similarities of the products with each other according to a mathematical model applied to the numerical values of the plurality of features.

4. The method of claim 3, wherein designating a recommend product to the user through the electronic commerce system is further according to the calculated similarities of the recommended product to the anchor product.

5. The method of claim 3, wherein presenting the designated recommended product to the user comprises presenting a side-by-side comparison of the features of the anchor product with the features of the designated recommended product.

6. The method of claim 5, further comprising:
tracking user selection of features of the products;
wherein features in the side-by-side comparison are arranged according to a frequency with which users select each feature through the electronic commerce system.

7. The method of claim 5, further comprising:
receiving user input directed to an arrangement of features in the side-by-side comparison; and
arranging features in the side-by-side comparison according to the user input directed to arrangement.

8. The method of claim 5, further comprising:
accentuating differences between the features of the anchor product and the features of the designated recommended product in the side-by-side comparison.

9. The method of claim 5, wherein designating a recommended product comprises designating two or more recommended products, the method further comprising:
providing an indication in the side-by-side comparison of at least one of the two or more recommended products being a best-seller.

10. The method of claim 1, further comprising:
determining a skill level of the user;
wherein designating the recommended product for recommendation to the user is further based on the determined skill level.

11. The method of claim 1, further comprising:
retrieving a preference of the user from a profile associated with the user;
wherein designating the recommended product for recommendation to the user is further based on the preference.

12. The method of claim 1, further comprising:
determining a location of the user;
wherein designating the recommended product for recommendation to the user is further based on the location of the user.

13. The method of claim 1, wherein the recommended product is a first designated product, the method further comprising:
determining a second designated product according to a frequency with which the second designated product is compared with anchor product based on the tracking; and
suppressing the second designated product from being recommended to the user.

14. The method of claim 1, wherein designating a recommended product is further according to an expert recommendation.

15. The method of claim 1, wherein designating a recommended product comprises one or more of:
confirming that the designated recommended products has available inventory;
confirming that the designated recommended product has a review rating that exceeds a threshold; or
confirming that the designated recommended product is available in a delivery channel selected by the user.

16. A method comprising:
tracking user selections of features of a plurality of reference products on an electronic commerce system;
determining and storing a ranking of the features, the ranking based on the tracked user selections; and
causing a listing of features of at least one of the reference products to be displayed to a user in the electronic commerce system, the features in the listing arranged according to the stored ranking.

17. The method of claim 16, wherein causing a listing of features of the at least one reference product to be displayed comprises causing a simultaneous listing of features of a plurality of the reference products to be displayed.

18. The method of claim 17, wherein causing a simultaneous listing of features of a plurality of reference products to be displayed is responsive to a user selection of a product comparison tool on the electronic commerce system.

19. The method of claim 16, wherein each reference product is classified into a respective one of a plurality of product categories, wherein the ranking of features is separate for each category.

20. The method of claim 16, further comprising:
receiving a user selection of an anchor product through an electronic user interface of the electronic commerce system; and
designating a reference product for recommendation to the user through the electronic commerce system according to respective similarities of the reference product to the anchor product, the similarities determined according to the features of the reference product and the anchor product;
wherein causing the listing of features of the reference product to be displayed comprises causing a listing of features of the recommended product to be displayed with a listing of the same features of the anchor product.

21. The method of claim 20, further comprising:
assigning respective numerical values to the features of the reference product; and
calculating respectively similarities of features of a first reference product with features of a second reference product according to a mathematical model applied to the numerical values of the features.

22. The method of claim 21, wherein the mathematical similarity model comprises one or more of the following:
a cosine similarity model;
a Euclidean distance;
a manhattan distance;
a weighted cosine similarity model; or
a weighted manhattan distance.

23. The method of claim 20, wherein the anchor product is discontinued and the designated recommended product is not discontinued.

24. The method of claim 16, further comprising:
tracking a trend of user selections of features of the reference product on an electronic commerce system;
wherein the listing of features comprises an indication of a trend of user selections of one or more of the displayed features.

25. The method of claim 16, further comprising:
determining a skill level associated with the user;
wherein designating the recommended product for recommendation to the user is further based on the determined skill level.

26. The method of claim 16, further comprising:
determining a location of the user;
wherein designating the recommended product for recommendation to the user is further based on the location of the user.

27. The method of claim 16, further comprising:
extracting one or more features of the reference product from one or more user reviews of the reference product on the electronic commerce system; and
adding the extracted one or more features to the respective listing of features of the reference product.

28. A method of providing product recommendations, comprising:
tracking user comparisons of products on an electronic commerce system;
tracking user selections of features of the products on the electronic commerce system;
determining and storing a ranking of the features, the ranking based on the tracked user selections;
receiving a user selection of an anchor product from reference products through an electronic user interface of the electronic commerce system;
determining, based on the tracked user comparisons, respective frequencies with which the reference products of the products are compared with the anchor product;
determining, based on the ranking of the features, respective similarities of the reference products to the anchor product;
designating a recommended product from the reference products for recommendation to the user through the electronic commerce system according to the determined frequencies and the determined similarities; and
presenting the designated the recommended product to the user responsive to the user's selection of the anchor product.

29. The method of claim 28, wherein the recommended product is a first recommended product, the method further comprising:
designating a second recommended product from the reference products for recommendation to the user further without respect to (i) a frequency with which the second recommended product is compared with the anchor product or (ii) a similarity of the second recommended product to the anchor product relative to the respective similarities of other reference products to the anchor product.
